(19) United States
(12) Patent Application Publication
(10) Pub. No.: US 2004/0181924 A1
(43) Pub. Date: Sep. 23, 2004

(54) Removable lug nut locking apparatus, cover, removal tool and methods of use

(76) Inventors: John H. Saunders II, Greenville, SC (US); David J. Smith, Columbia, SC (US)

Correspondence Address: Tony D. Alexander, TECHNOLOGY LEGAL COUNSEL LLC, POST OFFICE BOX 1728, EVANS, GA, 30809, US

(21) Appl. No.: 10/393,631

(22) Filed: Mar. 19, 2003

(51) Int. Cl. B23P 19/04

(52) U.S. Cl. 29/426.5; 29/267

(57) ABSTRACT

The present invention provides a new and useful device for reversibly locking vehicle lug nuts in a stationary position. One of the unique abilities of the present invention is the capacity to lock the lug nuts at roughly the exact degree of tension from the time the apparatus is installed until the apparatus is intentionally removed. A preferred embodiment of the present invention provides an apparatus for locking vehicle lug nuts in a stationary position so as to prevent premature loosening and dislocation during routine vehicle use. The apparatus can withstand extreme differentials in environmental conditions without compromising the degree of tension of the lug nuts. In the furtherance of this and other objectives, the apparatus is preferably designed with a removable cover that can withstand conditions such as wide temperature variances, various forms of moisture, road dirt and salt, metal fatigue and rust, and high heat transference from brakes. In particular, the apparatus prevents the lug nuts and threads from exposure to road salt, sand, dirt, and other road contaminants.

### FIELD OF THE INVENTION

The present invention relates generally to vehicle safety accessories and more particularly to an apparatus and cover for reversibly locking and covering vehicle lug nuts and methods of installing and removing the same.

### BACKGROUND OF THE INVENTION

In the current economic climate, states are scrambling to find ways to narrow their deficits. In so doing, many state funded programs or state programs competing for precious federal dollars are being cut or even eliminated. One such program that is being pinched significantly is the motor carrier inspection program, which is provided in one form or another in just about every state in the nation. For example, Michigan motor carrier inspectors are probing far fewer commercial trucks for mechanical shortcomings today than in past years. That is in part because fewer officers are watching Michigan roads for problem trucks. According to the Michigan State Police Motor Carrier Division, as of the late 1990s, Michigan had about 97 commercial truck inspectors, compared to 106 in 1993. In 1997, they examined 31,106 rigs for assorted mechanical and driver problems, compared to nearly 38,000 five years early. Southern Border States, such as Texas, have an even greater burden, as they have to monitor trans-border motor carrier traffic as well.

Truck traffic on state roads has increased by about 35 percent over the past decade, which suggests that states should be inspecting more trucks rather than fewer trucks. With the number of commercial trucks on the nation's roads increasing as the resources directed to commercial truck inspections are being cut, serious safety concerns may result. This combination translates into a significant number of commercial vehicles on the road that have not and likely will not be thoroughly inspected on a regular basis. As a result, states must rely on self policing measures that would encourage trucking companies in general and individual truck drivers in particular to inspection/maintain their vehicles on a recurring schedule. Though there are laws in place that require companies to inspect their trucks daily before they are placed in service, some safety issues may not be preventable by these routine checks.

A principal drawback of these routine inspections is that they rely heavily on visual monitoring, taking measurements and compiling written records of lug nut alignment over time. Besides being burdensome and subject to frequent human error, such methods do not address the need to prevent lug nut movement. Additionally, even if a lug is measured to have moved only slightly, that does not sufficiently insure against the lug being internally defective or subject to dislocation under environmental conditions not present prior to the previous inspection. For example, a lug nut may be tight when a truck is initially placed in service, but if it becomes displaced or loosened, for one reason or another, a disaster could result.

The above notwithstanding, one of the greatest safety concerns is that for a large number of vehicles on the nation's highways the wheels are not required to be inspected at all. In particular, lighter vehicles that are placed into service, or family vehicles for that matter, may not be subject to these inspection rules. It should also be noted that during standard vehicle operation, lug nuts could become loose merely by being in dynamic relation to the wheel. Vehicle lug nuts that become loose over time, during normal operation, allow the wheels to come off the vehicle while it's moving, leading to potentially catastrophic results.

Therefore, there is an existing need for a means of preventing loose, damaged or missing lug nuts to result in wheel detachments from trucks, automobiles, busses, and trailers. Moreover, a need exists for an apparatus that will keep freshly tightened lug nuts at relatively the same level of tension for an indefinite period of time. A need also exists for a removable apparatus that can facilitate inertness of the lugs during vehicle operation to ensure the lug nuts remain completely tight and secure during operation. An additional need remains for an apparatus that can withstand extreme differentials in environmental conditions without compromising the degree of lug nut tension. There also remains a need for an apparatus that provides the above features while being amenable of economical mass production.

### SUMMARY OF EXEMPLARY EMBODIMENTS

The present invention provides a new and useful apparatus for reversibly locking vehicle lug nuts in a stationary position. One of the unique abilities of the present invention is the capacity to lock the lug nuts at roughly the exact degree of tension from the time the apparatus is installed until the apparatus is intentionally removed.

It is, therefore, a principal object in accordance with a preferred embodiment of the present invention to provide a novel apparatus for protecting vehicle lug nuts.

It is also a principal objective in accordance with a preferred embodiment of the present invention to provide an apparatus for locking vehicle lug nuts in a stationary position so as to prevent premature loosening and dislocation during routine vehicle use.

Another objective of a preferred embodiment of a lug nut locking mechanism in accordance with the present invention is to provide an apparatus that can withstand extreme differentials in environmental conditions without compromising the degree of tension of the lug nuts. In the furtherance of this and other objectives, the apparatus is preferably designed with a removable cover that can withstand conditions such as wide temperature variances, various forms of moisture, road dirt and salt, metal fatigue and rust, and high heat transference from brakes. In particular, the apparatus prevents the lug nuts and threads from exposure to road salt, sand, dirt, and other road contaminants.

Yet another objective in accordance with the present invention is to provide a cover to the apparatus that has an external finish that compliments the rims. In the furtherance of this and other objectives, the cover has an outer finish that is for example, chrome, to add a decorative look to the apparatus.

Still another objective in accordance with the present invention is to provide a family of apparatuses that fit varying lug nut sizes and vehicle types. To this end, a preferred apparatus would be designed with lug retainers that fit snuggly about the lug nuts in a reversible manner. The apparatus is preferably removed by utilizing a specially designed tool.

It is a further objective in accordance with the present invention to provide an apparatus that can be easily machined in large quantities at an economical price. In the furtherance of this and other objectives, a preferred apparatus is formed of a durable yet lightweight polymer that conforms to the contours of the lugs.

The present invention possesses many advantages and features. Further objectives, features and advantages of the invention will become more apparent to those persons skilled in this area of technology and others when reading the detailed description of exemplary preferred embodiments of the present invention taken in conjunction with the accompanying drawings.

### BRIEF DESCRIPTION OF THE DRAWINGS

FIG. 1 is a conceptual view of a preferred embodiment of the present invention depicting a cover for a removable lug nut locking apparatus.

FIG. 2 is an aerial conceptual view of an exemplary cover as shown in FIG. 1.

FIG. 3 is an aerial perspective view of a preferred embodiment of a cover for a removable lug nut locking apparatus, in accordance with the present invention.

FIG. 4 is a side elevational view of the cover for a removable lug nut locking apparatus shown in FIG. 3.

FIG. 5 is an aerial perspective view of an exemplary removable lug nut locking apparatus.

FIG. 6 is an aerial perspective view of an exemplary removable lug nut locking apparatus as substantially shown in FIG. 5.

FIG. 7 is a perspective view of the bottom of the removable lug nut locking apparatus shown in FIG. 5.

FIG. 8 is an aerial plan view of an inverted removable lug nut locking apparatus and cover, in accordance with an embodiment of the present invention, showing a preferred mechanism for locking the cover to the apparatus.

FIG. 9 is a rear oriented plan view of the cover locking mechanism shown in FIG. 8.

FIG. 10 is a conceptual view of a removable lug nut locking apparatus removal device in accordance with present invention.

FIG. 11 is aerial perspective view of the removable lug nut locking apparatus removal device in accordance with a preferred embodiment of the present invention shown schematically in FIG. 10.

FIG. 12 is an enlarged perspective view of the treading on the interior surface of the removable lug nut locking apparatus shown in FIG. 5.

FIG. 13 is a perspective view of the underside of a removable lug nut locking apparatus showing the threading within the retainer.

FIG. 14 is a schematic representation of how the removal tool is used to remove the lug nut locking apparatus in practice.

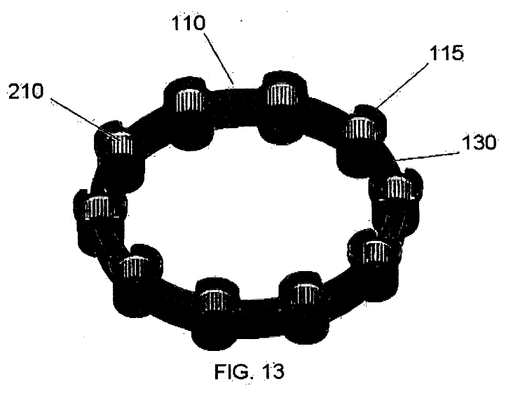

FIG. 13 is an alternative representation of how the removal tool is used to remove the lug nut locking apparatus in practice.

### DETAILED DESCRIPTION OF THE PREFERRED EMBODIMENTS

The present invention addresses the limitations of other vehicle safety measures while providing additional advantages. In a preferred embodiment, the present invention provides a sleek lug nut locking apparatus that can accommodate various vehicle wheel sizes and keep the lugs in a stationary position during vehicle operation. In the furtherance of this objective, an exemplary apparatus has at least one protective retainer that encircles the lug in a manner that protects the lug and threads from environmental injury while sufficiently immobilizing the lug. In a preferred embodiment, by linking all of the lugs together, by providing an integrated apparatus having a plurality of lug retainers, the lugs are prohibited from rotating, in relation to the wheel, as it would require all of the retaining hubs and the connecting members to fail simultaneously. Moreover, the user of the apparatus will quickly appreciate that the degree of lug tension at the time of installation will be substantially the degree of tension when the apparatus is later removed.

The apparatus is preferably lightweight for easy installation while the material is still durable. Throughout this specification reference shall be made to various components of the apparatus, however, each of these components can be made of different suitable materials and be present in different amounts and extents without departing from the spirit of the invention. As a result, reference to material, number, dimensions etc, should in no way be construed as limiting but rather considered as examples of preferable information for making and using the apparatus.

The following reference numbers and corresponding removable lug locking apparatus, cover and removal tool components are used when describing these items in relation to the figures:

| | |
|---|---|
| 110 | PROTECTION AND LOCKING APPARATUS |
| 115 | LUG RETAINER |
| 120 | LUG RETAINER INTERIOR SURFACE |
| 125 | LUG RETAINEER EXTERIOR SURFACE |
| 130 | CONNECTION MEMBERS |
| 135 | CONNECTION MEMBEER INTERIOR SURFACE |
| 140 | CONNECTION MEMBER EXTERIOR SURFACE |
| 145 | REMOVAL TOOL |
| 150 | ELONGATED MEMBER |
| 155 | ELONGATED MEMBER FIRST END |
| 160 | ELONGATED MEMBER SECOND END |
| 165 | ELONGATED MEMBER FLANGE |
| 170 | COVER |
| 175 | COVER HUBS |
| 180 | COVER CONNECTION MEMBERS |
| 185 | COVER INTERIOR SURFACE |
| 190 | COVER EXTERIOR SURFACE |
| 195 | LOCKING MECHANISM |
| 200 | LOCKING MECHANISM FLANGE |
| 205 | LOCKING MECHANSIMS LIP |
| 210 | THREADS |

The apparatus is preferably a plastic compound ring that in pressed over all the wheel's lug nuts either sequentially or simultaneously, but may be formed of other materials such as alternative polymers, metals, metalloids, or combinations thereof. The material flexes to cover the lug nuts. Once covered, the material surrounding the lug nuts holds on to the nut preventing any movement. Unlike hubs that are splined, which by definition permit the transmission of rotation or translatory motion along the axis of the shaft, See, The McGraw-Hill Dictionary of Scientific and Technical Terms, Fifth Edition, pg. 1891, the present retainers do not allow rotation. Moreover, in a preferred embodiment, the retainers have threads that grip, inter alia, along the hex pattern of the lug nuts to enhance the degree of retention. For purposes of this discussion, threads may be a plurality of individual vertical or horizontal protrusions formed on the interior surface of the retainer or alternatively may comprise a single of a multiplicity of continuous helical ribs formed thereon that prohibit rather than facilitate rotational dislocation. Moreover, because the cover connects all lug nuts in a ring, the ring connection also prevents any lug movement. It should be emphasized that in accordance with the present invention, there may be embodiments that comprise as few as two retainers coupled together by a single connection member. Though not forming a ring, such embodiments still exemplify the fundamental characteristics of lug nut retention and lug movement. It should also be understood that the connection member(s) may couple with the retainers at any number of locations along the outer surface of the retainer, from the top to the bottom thereof.

From an engineering standpoint, the rings are designed so that the material from which it is formed will have to slightly stretch to fit over the vehicles lug nuts. Each lug retainer is then attached together in preferably a concentric ring. The interior surface of each retainer that covers each lug nut is designed with grooves that are preferably substantially vertical in orientation; however, the grooves may be circumferential in a horizontal manner. These grooves aid in stretching, but more importantly they allow the points of the lug nut a secure place to seat. The combination of inner grooves holding the nut's points, along with the entire lug being squeezed by surrounding material, and all lugs being joined by a concentric ring prevents any movement. It should also be noted that the retainer itself may be shaped in a variety of forms, including but not limited to, the hex shape of the lug nut itself. Additionally, the apparatus is suitable for use in various climates ranging from sub-zero temperatures all the way up to about 250° F.

The cover fits directly onto the locking apparatus. It will attach to the ring by a close snug fit and four clips on the inside of the ring. The main function of the cover is to provide a chrome or decorative finish to the product. The center of the ring may be hollow (as shown in the figures) or solid like a hubcap for decorative purposes (not shown).

The removal tool is approximately 7″ long and 2″ wide. The unique characteristics are the flared handle and the arched bottom. The arched flange gives the tool the strength required to remove the product from the lug nuts. The height of the arch is also important, the perfect clearance to fit in the gap designed to pry the apparatus off the lug nuts.

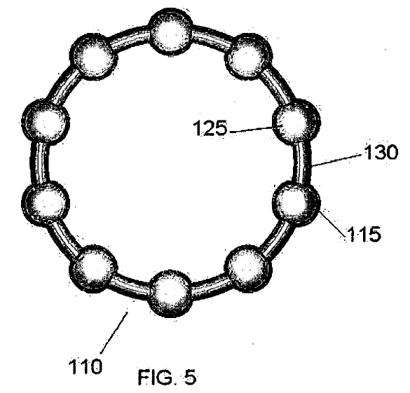

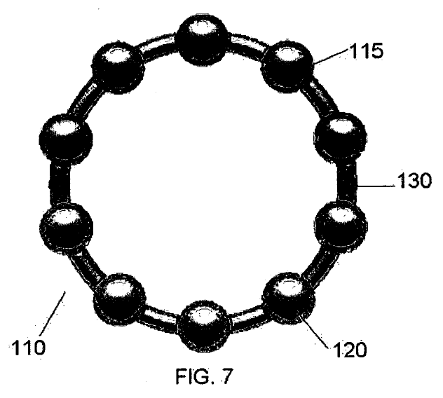

Reference will know be made to the figures generally, where like numerals refer to like components. In accordance with a preferred embodiment of the present invention, there is provided, as illustrated in FIG. 5-7, a novel device 110 for locking and protecting the lug nuts of a vehicle wheel assembly. In order to keep the device 110 lightweight yet durable, connection members 130 which form a spine connects a plurality of lug retainers 115. In a preferred embodiment, the device 110 has ten lug retainers 115 and ten connection members 130 that define a geometric shape. The geometric shape is preferably a circle or a polygon such as a triangle, square, or more preferably a decagon. However, other geometric shapes (not shown) could be arcuate or substantially linear as well; these geometric shapes particularly apply when fewer retainers are connected together with fewer connection members (e.g., an embodiment comprising a single connection member 130 connecting two retainers 115). In such a situation, a vehicle assembly having ten lug nuts would preferably use 5 separate apparatuses 110 and optionally a single cover 170. To this end, the cover 170 may provide additional inertness to the lugs in that it contributes supplementary stabilizing force to the apparatus 110.

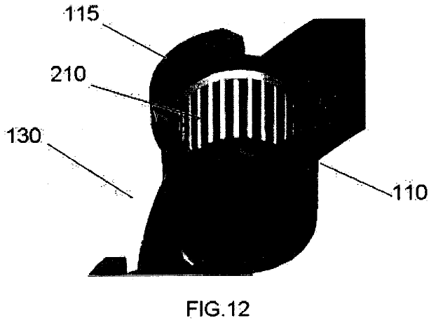

The apparatus 110 fits securely in place principally by the friction caused by the snug fit thereof. However, as an enhanced locking feature, the interior surface 120 of each lug retainer 115 is threaded to better grip the lug as specifically shown in FIGS. 12-13. As discussed throughout the specification, the threads 210 may be a plurality of individual vertical or horizontal protrusions formed on the interior surface 120 of the retainer 115 or alternatively may comprise a single of a multiplicity of continuous helical ribs formed thereon that prohibit rather than facilitate rotational dislocation.

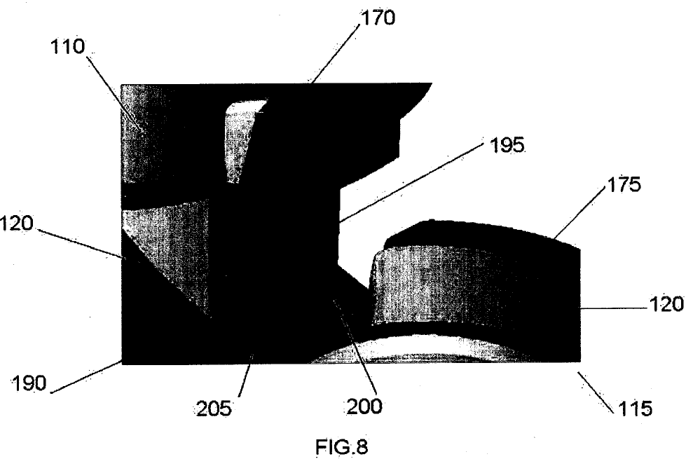

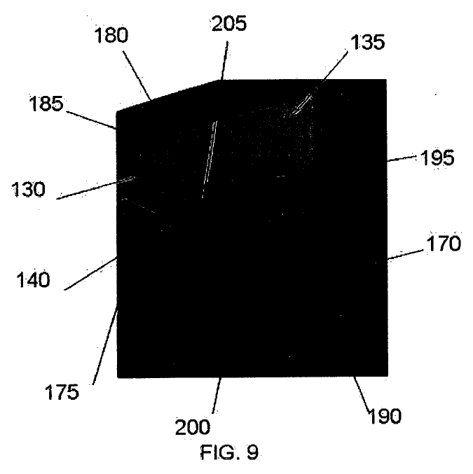

As a decorative enhancement, an optional cover 170 is provided that can substantially envelope the external circumference of the apparatus 110. The cover may be locked in place via a locking mechanism 195, shown most specifically in FIGS. 8-9. The locking mechanisms comprises a flange 200 that extends slightly beyond the bottom of the apparatus 110 and terminates with a lip 205 that overhangs the bottom of the apparatus 110 to prevent the apparatus 110 from prematurely disassociating from the cover 170. To this end, the cover 170 may be installed before or after the apparatus 110 has been installed on the wheel assembly.

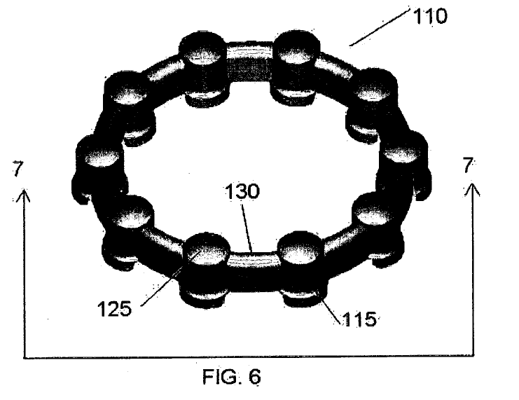

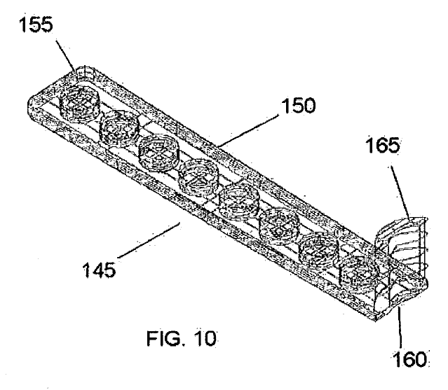

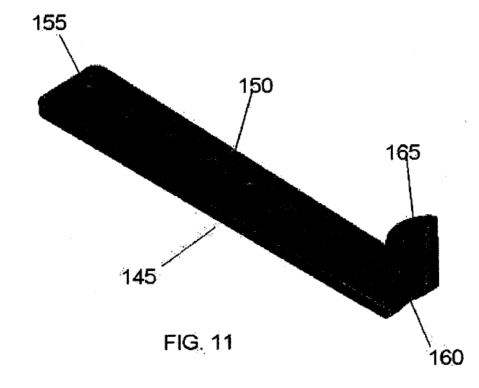

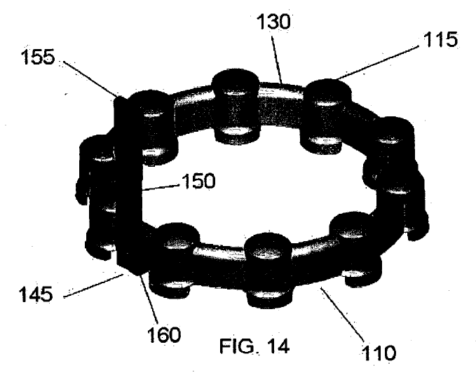

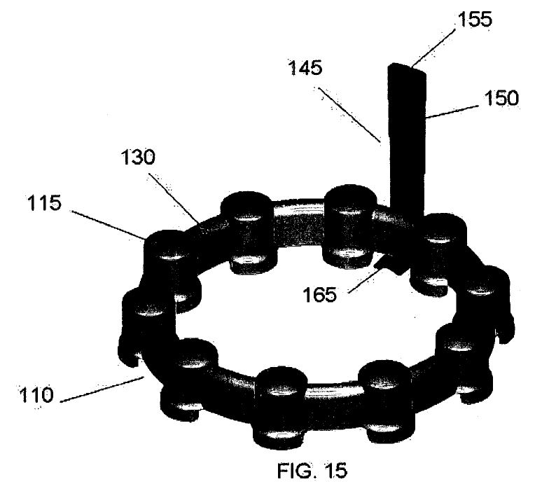

As shown specifically in FIG. 6, the connection members 130 are not flush with the bottom of the lug retainers 115. This facilitates both the removal of the apparatus 110 and locking of the cover 170 to the apparatus 110, as shown in FIGS. 8-9 and described above. With respect to removal, reference being specifically made to FIGS. 10-11 and 14-15, the flange 165 of the removal tool 145 may be inserted in that space formed between a connection member 130 and the two most adjacent retainers 115. When pressure, preferably outward, is exerted against the elongated member 160 of the removal tool 145, the apparatus 110 is urged upward and away from the vehicle wheel assembly in general and the lug nuts in particular.

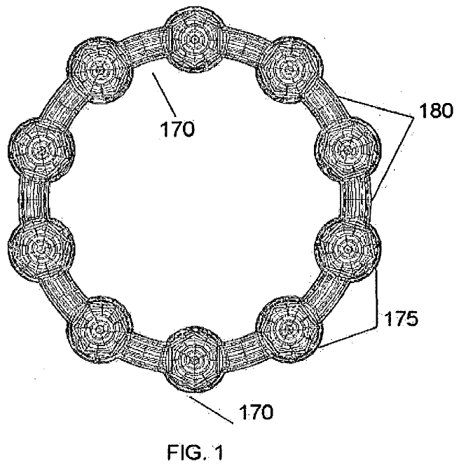

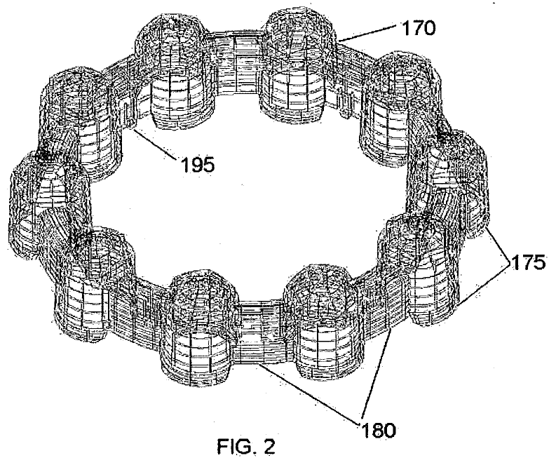

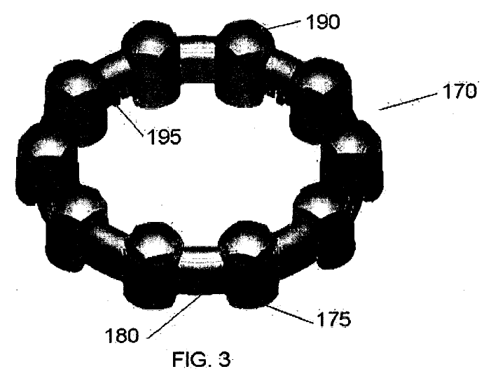

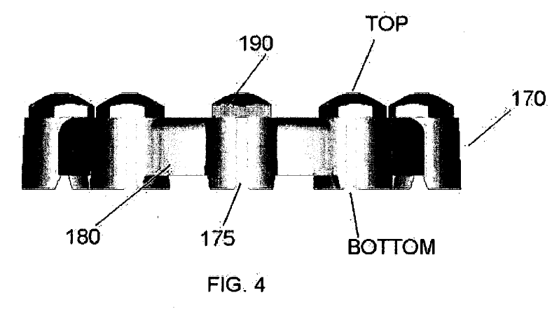

FIGS. 1-4 show a preferred embodiment of a decorative cover 170 for use with apparatus 110. It should be kept in mind that the cover 170 illustrated in the figures shows a ring-like structure but the invention should not be limited thereto. In alternative embodiments (not shown), the cover 170 would have a central planar surface that causes the cover 170 to resemble a car hubcap. It would be well within the ability of one of ordinary skill in the relevant art to provide various cover designs after exposure to the present disclosure. However, as illustrated in FIGS. 5-7 the cover 170 provides for a plurality of hubs 175 that are complementary to the lug retainers 115 of the apparatus 110. Additionally, the cover 170 comprises connection members 180 that have interior 170 and exterior 180 surfaces, wherein the interior surface 170 is disposed about the exterior surface 140 of the apparatus 110 connection members 130. As a result, the cover 170 is substantially complementary to the apparatus 110 in most respects. Once in place, the cover 170, via the locking mechanism 195 remains securely affixed to the apparatus 110 until voluntarily removed. It should be noted that one or more locking mechanisms 195 may be disposed about the cover 170 or the locking mechanism 195 may take a different form customary in the art, such as, latch, hook, snap, etc. Moreover, the locking mechanism 195 in this or alternate forms may be formed on the apparatus 110 rather than the cover 170.

Alternative embodiments in accordance with the present invention also provide the formation of the apparatus from a shape memory material that expands for placement and removal at one extreme temperature (e.g., greater than about 175° F. or less than about −50° F.) and conforms to and retains the lug nuts at an alternative less extreme temperatures (e.g., between the above ranges). A variety of shape memory materials are known in the art, such as nitinol, though cheaper, more malleable alternatives are envisioned.

There has been illustrated in the accompanying drawings and described hereinabove only one unique and novel preferred embodiment of the present invention which can be constructed in several different sizes and shapes. It should be understood that many changes, modifications, variations, and other uses and applications will become apparent to those persons skilled in this particular area of technology and to others after having been exposed to the present specification and accompanying drawings.

Any and all such changes, modifications, variations, and other uses and applications which do not depart from the spirit and scope of the present invention are therefore covered by and embraced within the present invention and patent application and the appended claims.

What is claimed is:

1. A protection and locking apparatus for use with vehicle wheel lug assemblies (having a plurality of lug nuts), comprising: a plurality of lug retainers, the retainers defining a cavity partially there through and operatively coupled with at least one other adjacent lug retainer via a connection member such that the apparatus takes on a substantially geometric shape, whereby the lug nuts are retained in an inert position during operation of the vehicle, when the apparatus is installed.

2. The apparatus of claim 1, wherein the retainer is formed from a material selected from the group consisting of polymers, metals, metalloids, or combinations thereof.

3. The apparatus of claim 2, wherein the material is plastic.

4. The apparatus of claim 1, wherein the substantially geometric shape is round.

5. The apparatus of claim 1, wherein the substantially geometric shape is a polygon.

6. The apparatus of claim 5, wherein the polygon is a decagon.

7. The apparatus of claim 1, wherein the lug retainers have interior and exterior surfaces.

8. The apparatus of claim 7, wherein the interior surface of the lug retainer is threaded.

9. The apparatus of claim 7, wherein the interior surface of the lug retainer covers substantially the entire circumference of the vehicle lug.

10. The apparatus of claim 8, wherein the interior surface of the lug retainer covers substantially the entire circumference of the vehicle lug.

11. The apparatus of claim 1, further comprising a decorative cover that that has an external and internal surface, the cover envelopes substantially the entire exterior surface of at least one of the lug retainers.

12. The apparatus of claim 11, wherein the external surface of the decorative cover is formed of an alloy material selected from the group consisting of polymers, metals, metalloids, or combinations thereof.

13. A tool for removing a protection and locking apparatus for use with vehicle wheel lug assemblies, comprising: an elongated member having a body, first and second ends, said second end defining a substantially curved flange that arcs in a plane perpendicular to that of the body of the elongated member, the flange set at an angle less than 180° with respect to the body of the elongated member.

14. The tool of claim 13, wherein the tool is formed of an alloy material selected from the group consisting of polymers, metals, metalloids, or combinations thereof.

15. A method of installing a protection and locking apparatus for use with vehicle wheel lug assemblies, comprising the steps of:
providing a vehicle having a wheel assembly with a plurality of lug nuts;
providing a protection and locking apparatus for use with vehicle wheel lug assemblies, comprising: a plurality of lug retainers, the retainers defining a cavity partially there through and operatively coupled with at least one other adjacent lug retainer via a connection member such that the apparatus takes on a substantially geometric shape having exterior and interior surfaces, whereby the lug nuts are retained in an inert position during operation of the vehicle, when the apparatus is installed; and
affixing the protection and locking apparatus securely about the plurality of lug nuts on the wheel assembly.

16. The method of claim 15, further comprising the step of providing a decorative cover for the protection and locking apparatus.

17. The method of claim 16, further comprising the step of affixing the decorative cover securely about the exterior surface of the protection and locking apparatus.

18. A method of removing a protection and locking apparatus for use with vehicle wheel lug assemblies, comprising the steps of:
providing a vehicle having a wheel assembly with a plurality of lug nuts with a protection and locking apparatus installed, the apparatus comprising: a plurality of lug retainers, the retainers defining a cavity partially there through and operatively coupled with at least one other adjacent lug retainer via a connection member such that the apparatus takes on a substantially geometric shape having exterior and interior surfaces, whereby the lug nuts are retained in an inert position during operation of the vehicle, when the apparatus is installed; and
providing a tool for removing the protection and locking apparatus for use with vehicle wheel lug assemblies, comprising: an elongated member having first and second ends, said second end defining a substantially curved flange that arcs in a plane perpendicular to that of the body of the elongated member, the flange set at an angle less than 180° with respect to the body of the elongated member; and
inserting the flange of the removal tool between the wheel assembly and a portion of the apparatus connection member;
exerting outward force against a portion of the elongated member of the removal tool such that the apparatus is urged upward in relation to the wheel assembly.

19. The method of claim 18, wherein the apparatus further comprises a cover affixed securely about the exterior surface of the protection and locking apparatus by a safety mechanism.

20. The method of claim 19, further comprising the step of removing the decorative cover by unlocking the safety mechanism.
